(19) United States
(12) Patent Application Publication
(10) Pub. No.: US 2013/0184906 A1
(43) Pub. Date: Jul. 18, 2013

(54) Control System For A Vehicle On An Incline

(71) Applicant: Joseph Lowell Harper, Waxhaw, NC (US)

(72) Inventor: Joseph Lowell Harper, Waxhaw, NC (US)

(73) Assignee: TEXTRON INC., Providence, RI (US)

(21) Appl. No.: 13/352,745

(22) Filed: Jan. 18, 2012

(51) Int. Cl. B60L 15/20

(52) U.S. Cl. 701/22

(57) ABSTRACT

A system for a vehicle includes a vehicle stability module that receives a commanded torque value, that determines whether to apply the commanded torque value based on at least one vehicle position characteristic, a position of an accelerator pedal, and a brake status, and that selectively outputs instructions to apply the commanded torque value in response to the determination. A torque control module receives the instructions from the vehicle stability module and applies a torque, corresponding to the commanded torque value, to at least one wheel of the vehicle based on the instructions.

### FIELD

The present disclosure relates to providing vehicle stability to electric utility vehicles on an incline.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Utility vehicles such as turf maintenance vehicles, cargo vehicles, shuttle vehicles, and golf cars may include a user or vehicle controlled braking system. The braking system may include a brake pedal or handbrake, an engine brake, or other software or hardware controlled electric braking.

### SUMMARY

A system for a vehicle includes a vehicle stability module that receives a commanded torque value, that determines whether to apply the commanded torque value based on at least one vehicle position characteristic, a position of an accelerator pedal, and a brake status, and that selectively outputs instructions to apply the commanded torque value in response to the determination. A torque control module receives the instructions from the vehicle stability module and applies a torque, corresponding to the commanded torque value, to at least one wheel of the vehicle based on the instructions.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an electric utility vehicle including a hill hold system and a roll back system according to the present disclosure;

FIG. 2 is a functional block diagram of a control module according to the present disclosure;

FIG. 3 is a functional block diagram of a vehicle stability module according to the present disclosure;

FIG. 4 is a flow diagram illustrating a hill hold method according to the present disclosure; and

FIG. 5 is a flow diagram illustrating a roll back method according to the present disclosure.

### DETAILED DESCRIPTION

Utility vehicles including, but not limited to, electric utility vehicles may experience vehicle roll-back events while positioned on a hill or other inclined surface. For example, if an accelerator pedal has been released while the vehicle is on an upward incline, the vehicle may roll backward before the brake is engaged. Conversely, the vehicle may roll forward if the vehicle is on a downward incline. Further, a vehicle may roll backward or forward if the brake becomes disengaged after a driver has left the vehicle. Accordingly, undesired movement may occur.

A hill hold and roll back system according to the present disclosure prevents unintended vehicle movement due to delay in applying the brake and/or the brake inadvertently becoming disengaged. For example, the hill hold and roll back system may calculate and apply torque to one or more wheels of the vehicle to prevent the vehicle from rolling.

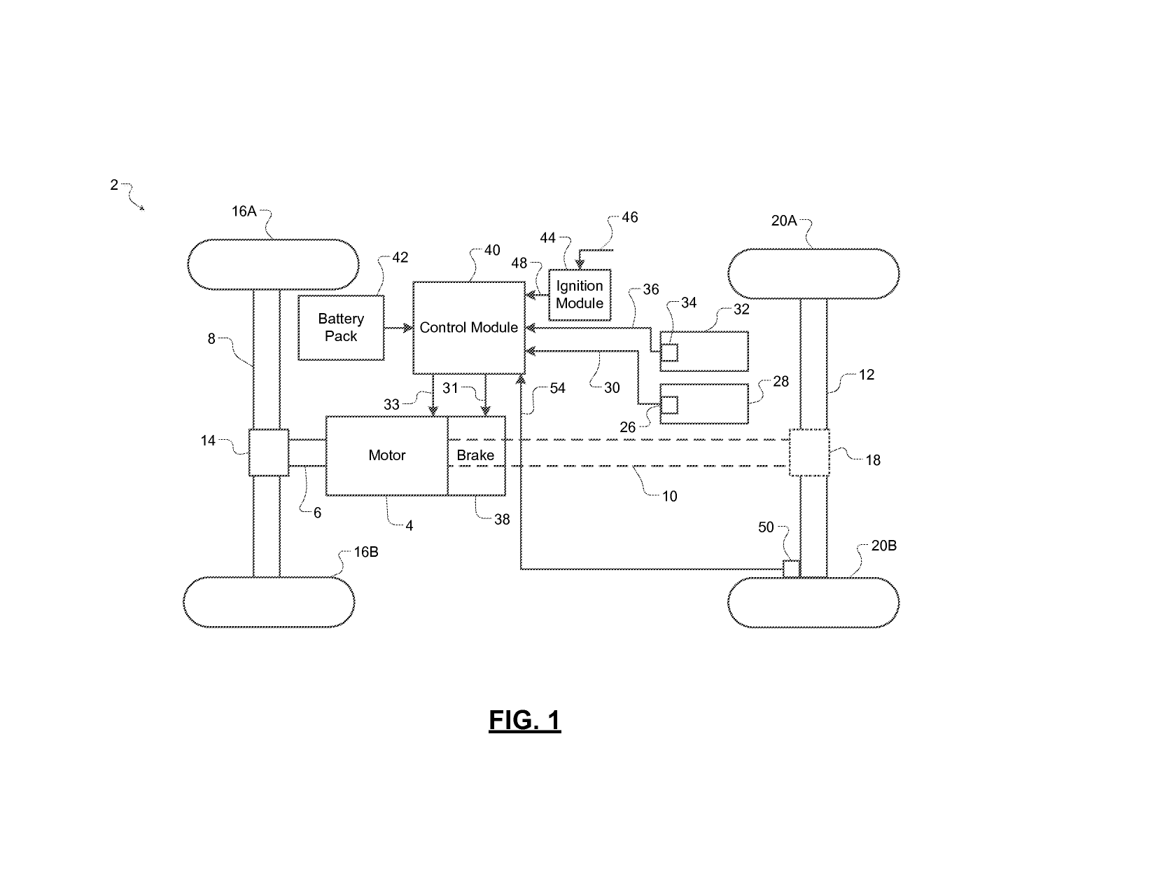

Referring now to FIG. 1, an example electric utility vehicle 2 implementing the hill hold and roll back system according to the principles of the present disclosure includes a motor 4 coupled through an output shaft 6 to an input shaft of a rear axle 8 and an output shaft 10 to an input of a front axle 12. The motor 4 may be any known electrical motor, generator, or motor generator technology, including, but not limited to AC induction machines, DC machines, synchronous machines, and switched reluctance machines. A differential 14 acts on the rear axle 8 to drive rear wheels 16A and 16B. A differential 18 acts on the front axle 12 to drive front wheels 20A and 20B. For example only, the vehicle 2 is a three-wheel drive (3WD) vehicle. However, it can be appreciated that any known drivetrain may be used, including, but not limited to, two-wheel drive and all-wheel drive.

The vehicle 2 includes at least one torque command sensor 26 and an accelerator pedal 28. The torque command sensor 26 generates a torque command signal 30 based on a torque command received from the accelerator pedal 28. For example, the torque command signal 30 may correspond to a position of the accelerator pedal 28 and indicate intended acceleration and/or speed of the vehicle 2. For example only, the torque command signal 30 may be an accelerator pedal position signal that is interpreted as the torque command signal 30. Although only the torque command signal 30 received from the accelerator pedal 28 is shown, it is to be understood that torque commands may be generated by any other suitable source within the vehicle 2. The vehicle 2 also includes a brake pedal 32 and a brake status sensor 34. The brake status sensor 34 generates a brake status signal 36 based on a status (e.g., position) of the brake pedal 32. Although only the brake pedal 32 is shown, it is to be understood that any known braking technology can be used, including, but not limited to, engine braking, a software brake, an emergency brake, and a parking brake.

An electromechanical brake 38 is coupled to the motor 4. A control module 40 controls the electromechanical brake 38 based on the brake status signal 36. A wheel movement sensor 50 generates a wheel movement signal 54 based on wheel movement (e.g., a change in position of one or more of the wheels 16A, 16B, 20A, and 20B). For example, the wheel movement may include clockwise or counterclockwise wheel movement, which is indicative of movement of the vehicle 2. The wheel movement sensor 50 provides the wheel movement signal 54 to the control module 40.

An ignition module 44 includes at least one ignition input 46 and an ignition signal 48. The ignition module 44 generates the ignition signal 48 based on the ignition input 46. The control module 40 may control the motor 4 based on the ignition signal 48. For example, the ignition input 46 may include a driver interface such as an ignition switch having a plurality of positions (i.e., states) including, but not limited to, start, run, and off.

The control module 40 may also provide current to the motor 4 to generate a commanded torque via a battery pack 42. The battery pack 42 may include any known battery technology, including, but not limited to, lead acid, lithium ion, and lithium polymer batteries. During normal operation, the commanded torque may be based on the desired acceleration and/or speed of the vehicle 2 as indicated by the torque command signal 30 or another commanded torque signal. In the vehicle 2 according to the principles of the present disclosure, the commanded torque may be based on one or more positional characteristics of the vehicle 2 (e.g., the wheel movement signal 54) and at least one of the torque command signal 30 and the brake status signal 36 when the accelerator pedal 28 is released and the brake pedal 32 is not yet applied, or the brake 38 becomes disengaged after being applied. For example, the control module 40 may provide a commanded torque to the motor 12 to prevent movement of the vehicle 2 when on an incline, or to control the speed of the vehicle when movement occurs as a result of the brake pedal 32 (and/or the brake 38) becoming inadvertently disengaged.

Referring now to FIG. 2, the control module 40 includes a commanded torque module 104, a vehicle stability module 108, a torque control module 112, a vehicle position characteristics determination module 116, a brake status determination module 120, and an accelerator status determination module 124. The commanded torque module 104 receives one or more commanded torque signals 126 corresponding to a commanded torque for the vehicle 2 (e.g., including the torque command signal 30, which may correspond to driver commanded torque, as well as commanded torque from any other source within the vehicle 2) and stores a corresponding commanded torque value. The commanded torque module 104 may store only a current (i.e., most recent) commanded torque value, or may store a plurality of commanded torque values corresponding to an immediately preceding period (e.g., all of the commanded torque values in the preceding 5 seconds). For example only, the commanded torque value may correspond to a last forward torque applied to a third wheel in a 3WD vehicle. The commanded torque module 104 provides the current commanded torque value to the vehicle stability module 108. For example only, the current commanded torque value may include a last driver commanded torque (e.g., corresponding to a position of the accelerator pedal 28).

The vehicle position characteristics determination module 116 determines one or more position characteristics of the vehicle 2. For example, the position characteristic may correspond to the wheel movement signal 54 and indicate that the wheels are moving, which is further indicative of vehicle movement. The one or more position characteristics may include other suitable indications of vehicle movement, including, but not limited to, global position system (GPS) data and a motion sensor signal. Even if the vehicle 2 is not actually moving, the one or more position characteristics may also indicate that the vehicle 2 is in a position where vehicle movement is possible, such as tilt and/or incline sensor data, and/or GPS data that indicates that the vehicle is located on uneven terrain. The vehicle position characteristics determination module 116 provides the one or more position characteristics to the vehicle stability module 108.

The brake status determination module 120 determines a status of the brake pedal 32 based on the brake status signal 36. For example, the brake status signal 36 may correspond to a position of the brake pedal 32, which is indicative of whether the brake pedal 32 is engaged or disengaged. The brake status determination module 120 provides the status of the brake pedal 32 to the vehicle stability module 108. Conversely, the accelerator status determination module 124 determines a status (e.g., position) of the accelerator pedal 28 based on the torque command signal 30. For example, the torque command signal 30 may be based on the position of the accelerator pedal 28, which is indicative of whether the accelerator pedal 28 is engaged or disengaged. The accelerator status determination module 124 provides the status of the accelerator pedal 28 to the vehicle stability module 108.

The vehicle stability module 108 selectively generates instructions (e.g., instructions to apply a commanded torque) based on the commanded torque value, the one or more position characteristics, the status of the brake pedal 32, and the status of the accelerator pedal 28. The vehicle stability module 108 may also communicate with the ignition module 44 and selectively generate the instructions further based on a position of the ignition input 46.

In particular, the vehicle stability module 108 generates the instructions to implement hill hold and/or vehicle roll back functions according to the principles of the present disclosure. For example, to implement the hill hold function, the vehicle stability module 108 determines whether the vehicle 2 is moving (or is in a position where unintended movement is possible) based on the one or more position characteristics and selectively generates the instructions based on the determination if one or more other conditions are present (e.g., the ignition input 46 is in the “off” position and/or the accelerator pedal 28 is disengaged, and the brake pedal 32 is not engaged). For example, if the vehicle 2 was previously travelling upward on an inclined surface prior to stopping, the current commanded torque value may correspond to a minimum amount of torque necessary to prevent backward movement of the vehicle 2 in the opposite direction. Accordingly, if the driver 2 disengages the accelerator pedal 28 (thereby removing or reducing driver commanded torque), the vehicle 2 may roll backwards before the driver is able to engage the brake pedal 32.

In such a situation, the vehicle stability module 108 may conclude that if there is vehicle movement, then the movement of the vehicle 2 is unintended since, for example, the accelerator pedal 28 is disengaged. To prevent the unintended movement, the vehicle stability module 108 determines the last commanded torque (e.g., as received from the commanded torque module 104) and generates the instructions to apply the commanded torque value. The vehicle stability module 108 provides the commanded torque value to the torque control module 112. The torque control module 112 controls the motor 4 according to the commanded torque value. For example, if the commanded torque value corresponds to a last forward torque applied to a third wheel in a 3WD vehicle, the torque control module 112 may apply the commanded torque value to the third wheel.

The commanded torque value may be reversed based on a determination of which direction the vehicle 2 is moving or likely to move. For example, if the vehicle 2 was travelling on an upward incline before stopping, then wheel movement in an opposite direction may indicate that the vehicle 2 is moving backward. Accordingly, the vehicle stability module 108 provides instructions to apply the commanded torque value in a forward direction to prevent backward movement. Conversely, if the vehicle 2 was travelling on a downward incline before stopping, then wheel movement in the same direction may indicate that the vehicle 2 is moving forward. Accordingly, the vehicle stability module 108 provides instructions to apply the commanded torque value in a reverse direction to prevent forward movement.

The vehicle stability module 108 continues to provide the instructions to apply the commanded torque value until one or more conditions are met. For example, the vehicle stability module 108 may continue to provide the instructions until the brake pedal 32 is engaged and/or the accelerator pedal 28 is engaged, or for a predetermined period after the brake pedal 32 is engaged (e.g., for two seconds after the brake pedal 32 is engaged). Further, the vehicle stability module 108 may continue to monitor the one or more position characteristics and adjust the commanded torque value accordingly. For example, vehicle movement is still detected after the initial commanded torque value is applied, the vehicle stability module 108 may increase the commanded torque value. Conversely, if the initial commanded torque value results in vehicle movement in the opposite direction, the vehicle stability module 108 may decrease the commanded torque value. In this manner, the vehicle stability module 108 may iteratively adjust the commanded torque value until vehicle movement is no longer detected.

Conversely, to implement the vehicle rollback function, the vehicle stability module 108 may determine that the vehicle 2 is moving based on the one or more position characteristics after the brake pedal 32 is already engaged, a parking brake or the electromechanical brake 38 is engaged, and/or the ignition input 46 is in the “off” position. When the vehicle is parked and/or the driver exits the vehicle 2 when the vehicle 2 is on an incline, typically the brake pedal 32 and/or another braking mechanism is engaged to prevent vehicle movement. However, in some situations, the braking mechanism may inadvertently become disengaged, or an engaged braking mechanism may be unsuccessful, resulting in unintended vehicle movement.

Accordingly, if the brake pedal 32 or any other brake is engaged (and/or the ignition input 46 is in the “off” position) and vehicle movement is detected, the vehicle stability module 108 may conclude that the movement of the vehicle 2 is unintended. To control the unintended movement, the vehicle stability module 108 may determine rollback torque (e.g., based on the commanded torque value as received from the commanded torque module 104 and/or a rate of vehicle movement) and generate instructions to apply a commanded torque value based on the rollback torque. For example, the rollback torque may correspond to a minimum torque necessary to maintain movement of the vehicle 2 at a desired controlled rate. For example only, if the last commanded torque value corresponds to the minimum amount of torque necessary to prevent backward movement of the vehicle 2 in the opposite direction, the rollback torque may be slightly less than the last commanded torque. In other words, if the commanded torque value results in no vehicle movement on an incline, the rollback torque may correspond to a slow, controlled rate of movement down the incline. Conversely, if the vehicle 2 is rolling forward down a downward incline, the rollback torque may be applied in a reverse direction. For example only, the rollback torque may be applied to one or more traction assist wheels of the vehicle 2.

The vehicle stability module 108 generates the instructions corresponding to the rollback torque until vehicle movement is no longer detected. For example, as the vehicle 2 continues to roll at the controlled rate down the incline, the vehicle 2 may eventually stop. The vehicle stability module 108 therefore stops applying the rollback torque to prevent movement in the opposite direction. However, the vehicle stability module 108 continues to monitor the one or more position characteristics to determine whether the vehicle movement resumes. If the vehicle movement resumes, the vehicle stability module 108 again provides the instructions to the torque control module 112 to apply the rollback torque. Or, the vehicle stability module 108 may adjust (e.g., reduce) the rollback torque. In other words, since the previous rollback torque stopped the vehicle 2, vehicle stability module 108 may conclude that the degree of incline has decreased and reduce the rollback torque accordingly.

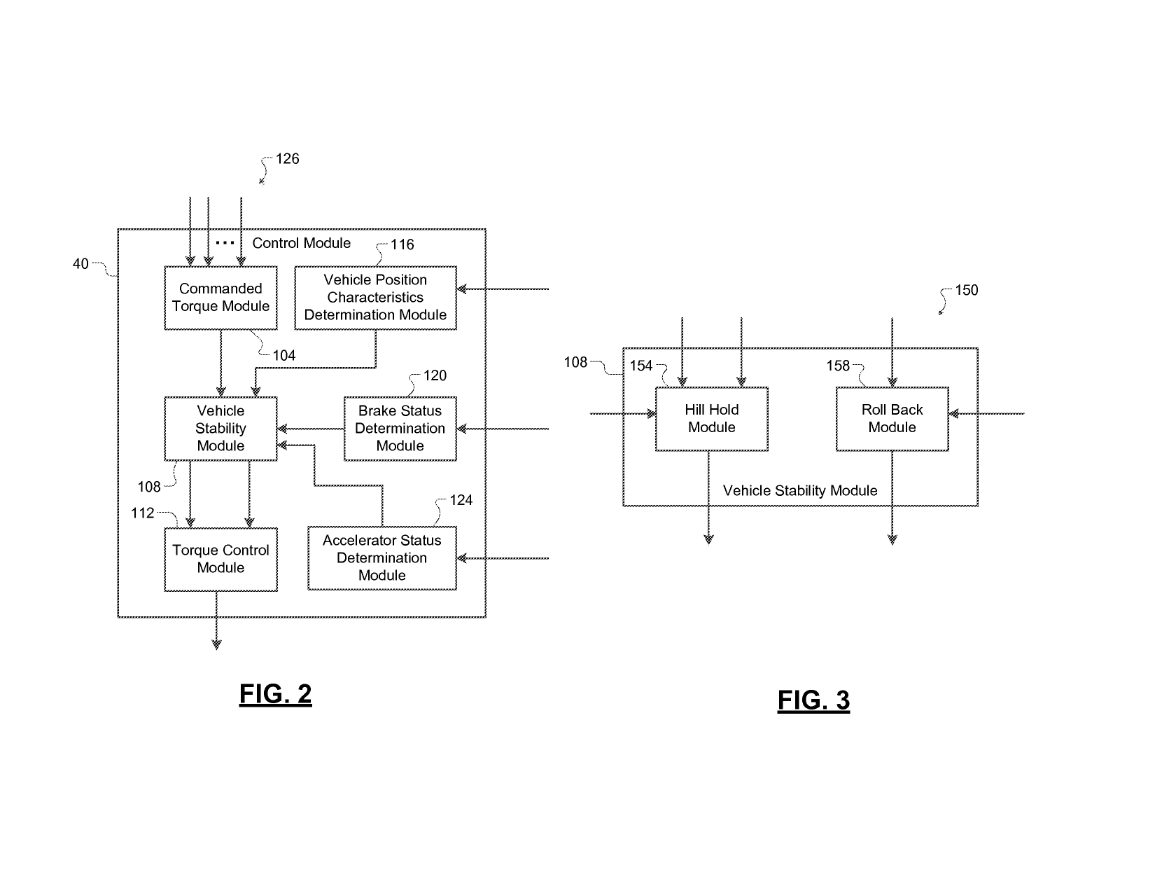

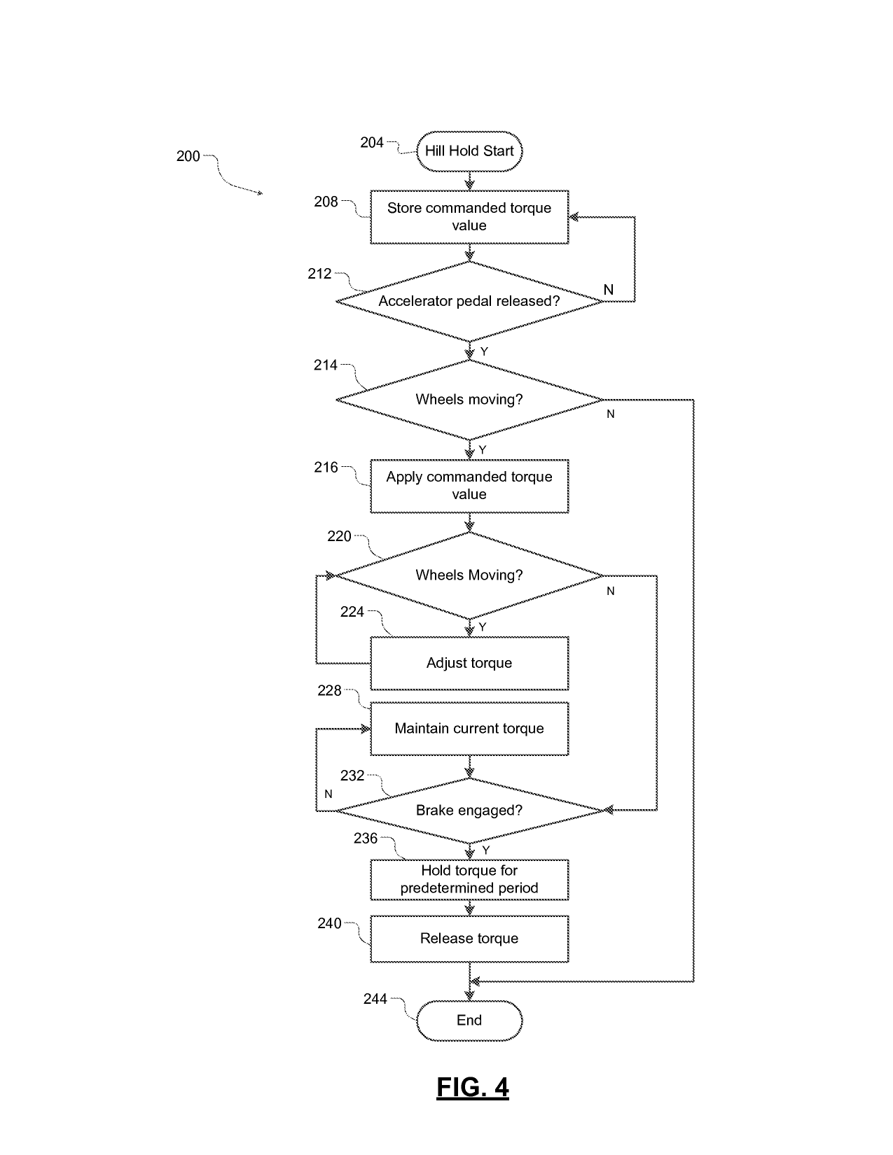

Referring now to FIG. 3, the vehicle stability module includes a hill hold module 154 and/or a roll back module 158. The hill hold module 154 receives the one or more position characteristics (e.g., an indicator of vehicle movement), the accelerator pedal status (e.g., a position of the accelerator pedal 28), the brake status, and the commanded torque value. The hill hold module 154 provides the instructions corresponding to the commanded torque value based on the one or more position characteristics, the accelerator pedal status, and the brake status.

The roll back module 158 receives the one or more position characteristics (e.g., an indicator of vehicle movement) and the brake status. The roll back module 158 provides the rollback torque (e.g., based on the commanded torque value) based on the one or more position characteristics and the brake status. Although both the hill hold module 154 and the roll back module 158 are shown, it can be appreciated that a vehicle stability module 108 may include and/or implement only the hill hold module 154 or the roll back module 158.

Referring now to FIG. 4, an electric vehicle hill hold method 200 begins at 204. At 208, the method 200 stores a commanded torque value. At 212, the method 200 determines whether the accelerator pedal has been released. If true, the method 200 continues to 214. If false, the method 200 returns to 208. At 214, the method 200 determines whether the wheels of the vehicle are moving. If true, the method 200 continues to 216. If false, the method 200 ends at 244. At 216, the method 200 applies the commanded torque value. At 220, the method 200 determines whether the wheels are moving. If true, the method 200 continues to 224. If false, the method 200 continues to 232. At 224, the method 200 adjusts the commanded torque value. At 232, the method 200 determines whether a brake is engaged. If false, the method 200 continues to 228. If true, the method 200 continues to 236. At 228, the method 200 maintains the current torque. At 236, the method 200 holds the torque for a predetermined period. At 240, the method 200 releases the torque. The method 200 ends at 244.

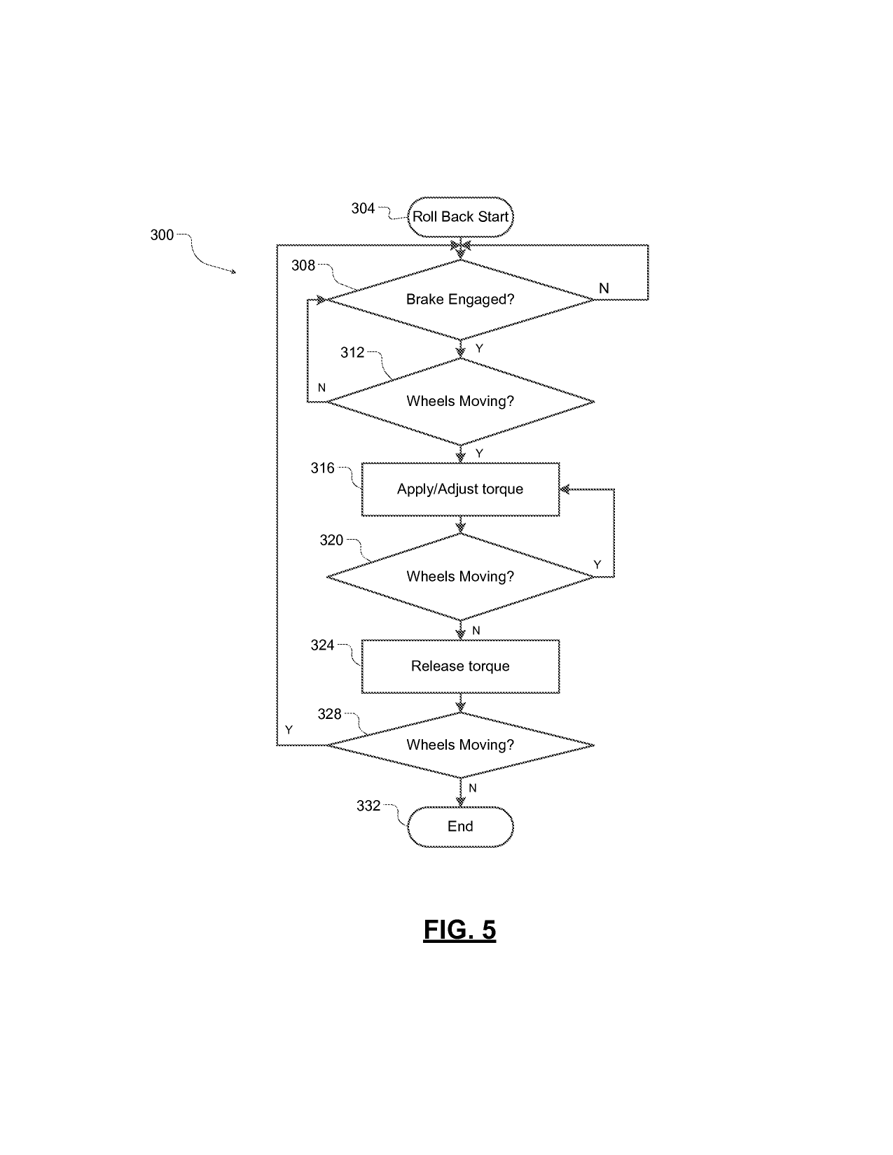

Referring now to FIG. 5, an electric vehicle roll back method 300 begins at 304. At 308, the method 300 determines whether a brake is engaged. If true, the method 300 continues to 312. If false, the method 300 returns to 308. At 312, the method 300 determines whether the wheels are moving. If true, the method 300 continues to 316. If false, the method 300 returns to 308. At 316, the method 300 applies a rollback torque. At 320, the method 300 determines whether the wheels are moving. If true, the method 300 returns to 316. If false, the method 300 continues to 324. At 324, the method 300 releases the applied torque. The method 300 continues to 328. At 328, the method 300 determines if the wheels are moving. If true, the method 300 returns to 308. If false, the method 300 ends at 332.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage. what is claimed is:

1. A system for a vehicle, the system comprising:
a vehicle stability module that receives a first commanded torque value, that determines whether to apply the first commanded torque value based on at least one vehicle position characteristic, a position of an accelerator pedal, and a brake status, and that selectively outputs instructions to apply a second commanded torque value in response to the determination; and
a torque control module that receives the instructions from the vehicle stability module and applies a torque, corresponding to the second commanded torque value, to at least one wheel of the vehicle based on the instructions.

2. The system of claim 1 wherein the vehicle stability module outputs the instructions to apply the second commanded torque value if the at least one vehicle position characteristic is indicative that the vehicle is moving, the position of the accelerator pedal indicates that the accelerator pedal is disengaged, and the brake status indicates that a brake is disengaged.

3. The system of claim 2 wherein the vehicle stability module outputs instructions to release the second commanded torque value if the at least one vehicle position characteristic indicates that the vehicle is not moving and at least one of:
the position of the accelerator pedal indicates that the accelerator pedal is engaged; and
the brake status indicates that the brake is engaged.

4. The system of claim 1 wherein the vehicle stability module does not output the instructions to apply the second commanded torque value if the at least one vehicle position characteristic indicates that the vehicle is not moving.

5. The system of claim 1 wherein the vehicle stability module increases the second commanded torque value if the vehicle is moving after the torque control module applies the torque.

6. The system of claim 1 wherein the torque control module maintains the torque for a predetermined period after a brake pedal is engaged.

7. The system of claim 1 wherein the at least one vehicle position characteristic is based on vehicle movement, and a direction of the torque is based on a direction of the vehicle movement.

8. The system of claim 1 wherein the vehicle stability module outputs the instructions to apply the second commanded torque value if the at least one vehicle position characteristic indicates that the vehicle is moving, the position of the accelerator pedal indicates that the accelerator pedal is disengaged, and the brake status indicates that a brake is engaged.

9. The system of claim 8 wherein the second commanded torque value corresponds to a controlled rate of vehicle movement.

10. The system of claim 8 wherein, after the torque control module applies the torque, the vehicle stability module adjusts the second commanded torque value if the vehicle stops moving.

11. A method for operating a vehicle, the method comprising:
receiving a first commanded torque value;
determining whether to apply the first commanded torque value based on at least one vehicle position characteristic, a position of an accelerator pedal, and a brake status;
selectively outputting instructions to apply a second commanded torque value in response to the determination;
applying a torque, corresponding to the second commanded torque value, to at least one wheel of the vehicle based on the instructions.

12. The method of claim 11 further comprising:
outputting the instructions to apply the second commanded torque value if the at least one vehicle position characteristic is indicative that the vehicle is moving, the position of the accelerator pedal indicates that the accelerator pedal is disengaged, and the brake status indicates that a brake is disengaged.

13. The method of claim 12 further comprising outputting instructions to release the second commanded torque value if the at least one vehicle position characteristic indicates that the vehicle is not moving and at least one of:
the position of the accelerator pedal indicates that the accelerator pedal is engaged; and
the brake status indicates that the brake is engaged.

14. The method of claim 11 further comprising:
not outputting the instructions to apply the second commanded torque value if the at least one vehicle position characteristic indicates that the vehicle is not moving.

15. The method of claim 11 further comprising increasing the second commanded torque value if the vehicle is moving after the torque control module applies the torque.

16. The method of claim 11 further comprising maintaining the torque for a predetermined period after a brake pedal is engaged.

17. The method of claim 11 wherein the at least one vehicle position characteristic is based on vehicle movement, and a direction of the torque is based on a direction of the vehicle movement.

18. The method of claim 11 further comprising outputting the instructions to apply the second commanded torque value if the at least one vehicle position characteristic indicates that the vehicle is moving, the position of the accelerator pedal indicates that the accelerator pedal is disengaged, and the brake status indicates that a brake is engaged.

19. The method of claim 18 wherein the second commanded torque value corresponds to a controlled rate of vehicle movement.

20. The method of claim 18 further comprising, after applying the torque, adjusting the second commanded torque value if the vehicle stops moving.
